(19) United States
(12) Patent Application Publication
(10) Pub. No.: US 2012/0232442 A1
(43) Pub. Date: Sep. 13, 2012

(54) GAIT TRAINING DEVICE

(76) Inventors: Shuoyu Wang, Kami-shi (JP); Kenji Ishida, Kochi-shi (JP); Hironobu Nagano, Kochi-shi (JP); Shingo Ino, Nangoku-shi (JP); Masakatsu Fujie, Shinjyuku-ku (JP)

(21) Appl. No.: 13/393,405

(22) PCT Filed: Aug. 31, 2010
(86) PCT No.: PCT/JP2010/064849

§ 371 Date: May 14, 2012

(30) Foreign Application Priority Data
Sep. 1, 2009 (JP) 2009-202077

(51) Int. Cl. A61H 1/00

(52) U.S. Cl. 601/26

(57) ABSTRACT

[Problem]

Provided is a gait training device allowing those who have lost muscle strength to support the upper bodies with severe gait disorder caused by accidents or operations etc. to perform gait training, producing good rehabilitation effect, and moving in a room without any difficulty.

[Solution]

The gait training device comprises a seat (1) set at the height allowing a user (R) to sit with his feet on the ground, a support member (2) to support said seat, and omnidirectional mobile members (3) attached to said support member (2).

### TECHNICAL FIELD

The present invention relates to a gait training device used to perform rehabilitation for recovering walking function.

### BACKGROUND OF THE INVENTION

As the population ages, more and more people have recently suffered from fall fracture, loss of muscle strength, decreased range of joint motion, reduced sense of balance or the like due to aging. Accordingly, more and more patients need rehabilitation of walking function.

Generally, rehabilitation of gait training is performed with assistance from caregivers, such as physical therapists and nurses, in facilities, such as hospitals. However, there have been some problems, such as increased physical burden to caregivers and insufficient training time due to a lack of physical therapists etc.

In view of these problems, many gait training devices allowing for a patient to perform gait training for himself without any assistance from physical therapists etc. have been proposed. However, some of them can move only back and forth, and thus are not suitable to move in a small room.

On the other hand, the disclosed technology of the patent document 1 to be proposed later by the present inventors has the structure which can move in all directions, and thus is suitable to move in a small room.

However, conventional gait training devices including the disclosed technology of the patent document 1 were applicable to only patients who have enough muscle strength to maintain their upright posture, because these devices are constituted on the assumption that users perform gait training in the upright posture, and they could not be used for training for those who have lost muscle strength to support the upper bodies due to severe gait disorder caused by accidents or operations etc.

Meanwhile, for those who have trouble performing gait training in the upright posture due to severe gait disorder, training devices (leg exercise therapy equipment) have been developed allowing them to move their legs, such as pedaling, while they are lying on the bed.

However, these devices can generally allow them to only pedal, not to walk with their feet on the ground, and thus the devices could not produce sufficient rehabilitation effect of walking function.

### THE PRIOR ART DOCUMENT

[Patent Document 1] JP Tokukai2003-062022

### [SUMMARY OF THE INVENTION]

### Problems to be solved by the Invention

The present invention is made in order to solve problems of the above-described conventional technology. The object of the invention is to provide a gait training device allowing those who have lost muscle strength to support the upper bodies due to severe gait disorders caused by accidents or operations etc. to perform gait training, producing good rehabilitation effect, and moving in a small room without any difficulty.

### Solution to solve the Problems

The invention according to claim 1 relates to a gait training device comprising a seat set at the height allowing a user to sit with his feet on the ground, a support member to support said seat, and omnidirectional mobile members attached to said support member.

The invention according to claim 2 relates to the gait training device of claim 1, comprising a forward-falling prevention member which prevents a user sitting on the seat from falling forward.

The invention according to claim 3 relates to the gait training device of claim 2 comprising a backrest to support the back of a user sitting on said seat, wherein said forward-falling prevention member consists of a substantially U-shaped guard handle in a planar view which can tilt from behind to front of the user about said backrest set as a supporting point and surround front, left and right sides of the user sitting on said seat while it is tilted forward.

The invention according to claim 4 relates to the gait training device of claim 2 comprising a backrest to support the back of a user sitting on said seat, wherein said forward-falling prevention member consists of a belt member attached to said backrest which can be wrapped around user's abdomen.

The invention according to claim 5 relates to the gait training device of claim 2, wherein said forward-falling prevention member consists of a substantially T-shaped front handle in a front view which is provided at the front of said seat and can be gripped with both hands of a user sitting on said seat.

The invention according to claim 6 relates to the gait training device relating to any of claims 1 to 5, wherein said seat is constituted so that its height can be adjustable.

### Effects of the Invention

According to the invention of claim 1, since a user can perform gait training while sitting on the seat, even those who have lost muscle strength to support the upper bodies due to severe gait disorder caused by accidents or operations etc. can perform gait training. That is, even severe patients who are not capable of using a conventional gait training device while they are upright in posture can perform gait training, only if they have enough muscle strength allowing them to sit on the seat.

Furthermore, since the device has the omnidirectional mobile members, it allows the user to easily move in all directions by walking while he is sitting on the seat and can produce good rehabilitation effect. In particular, since the device allows the user to move with his feet on the ground, it can produce remarkably beneficial effect compared to a conventional gait training device for severe patients with which they can, for example, pedal while they are lying on beds. Furthermore, by using the device, the user can also easily move in a small room.

According to the invention of claim 2, since the device comprises a forward-falling prevention member which prevents a user sitting on the seat from falling forward, it prevents a user from falling forward during training and thus can provide safe gait training.

According to the invention of claim 3, the device surrounds front, left, and right sides of a user with a guard handle by tilting the guard handle forward of the user, so that the device can prevent the user from falling forwardly or laterally during training and provide safe gait training. Furthermore, the device can return the guard handle backward of the user at the end of training so that the user can easily move away from the training device. Besides, the device can prevent the user from falling backward since it has a backrest.

According to the invention of claim 4, a belt member is wrapped around user's abdomen during training, so that the device can prevent the user from falling forward and provide safe gait training. Furthermore, the device can prevent the user from falling backward since it has a backrest.

According to the invention of claim 5, the user grips a front handle with both hands during training, so that the device can prevent the user from falling forward and provide safe gait training.

According to the invention of claim 6, since the seat is constituted so that its height can be adjustable, the height of the seat can be adjusted to fit a user's body type, gait training at the optimal height of the seat for individual users can be performed, and remarkable beneficial rehabilitation effect can be achieved.

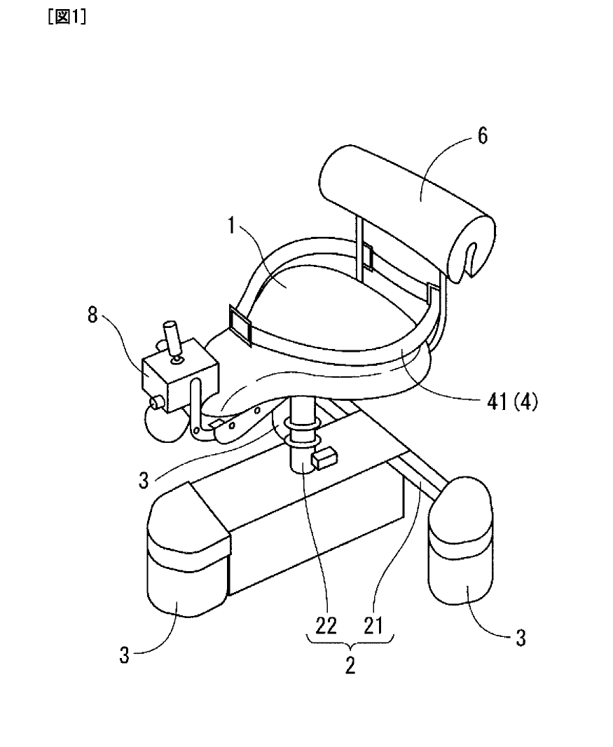

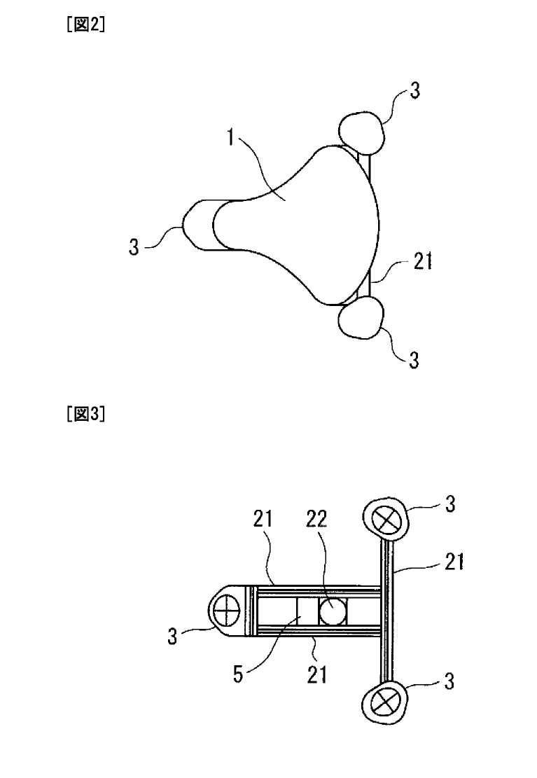

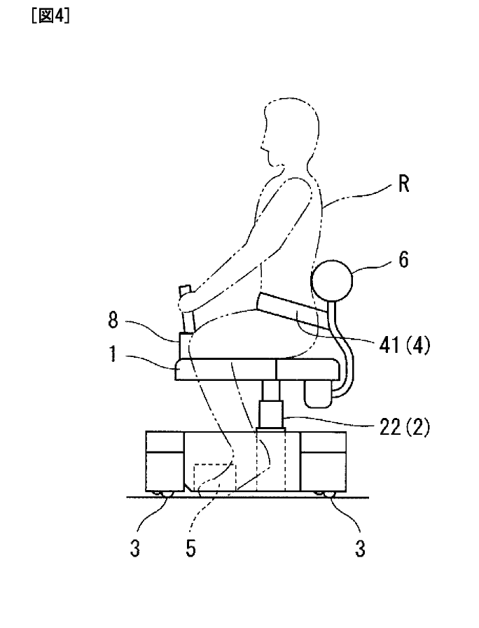

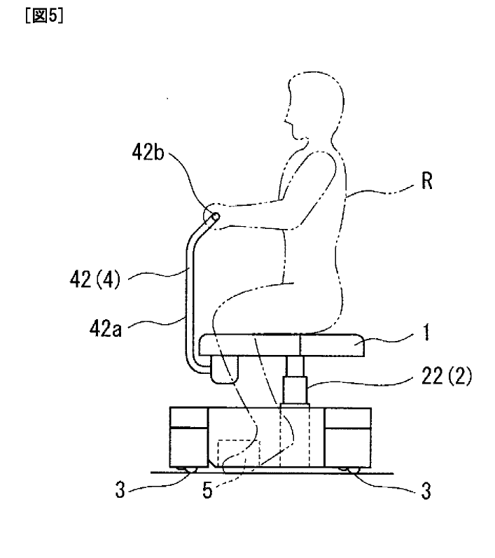

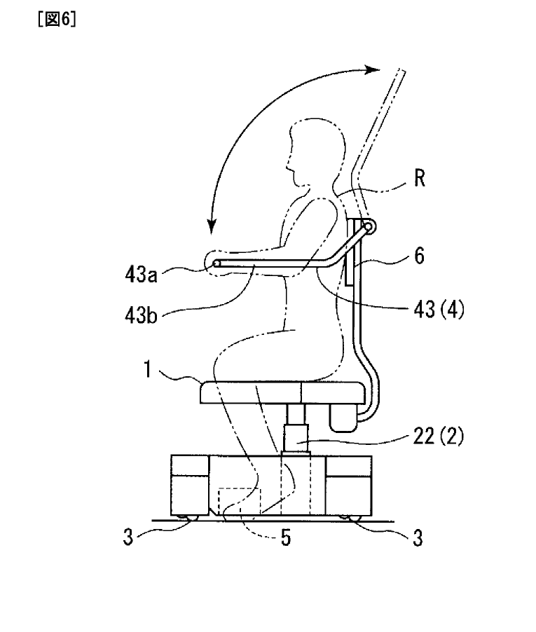

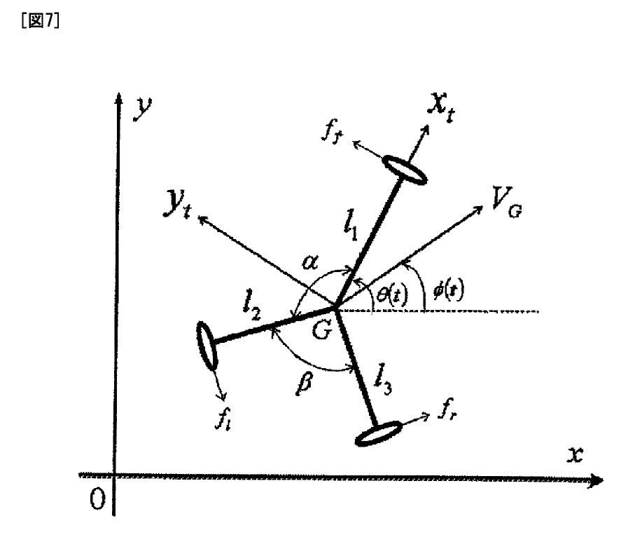

### BRIEF DESCRIPTION OF FIGURES

[FIG. 1] It is a perspective view showing a first embodiment of a gait training device according to the present invention.

[FIG. 2] It is a planar view seen downward from top surface of a seat.

[FIG. 3] It is a planar view seen downward from bottom surface of the seat.

[FIG. 4] It is a side view of the gait training device according to the present invention.

[FIG. 5] It is a side view showing a second embodiment of the gait training device according to the present invention.

[FIG. 6] It is a side view showing a third embodiment of the gait training device according to the present invention.

[FIG. 7] It shows a coordinate setting and a structural model for deriving kinematics and dynamics for the control of motion of the gait training device according to the present invention.

### DETAILED DESCRIPTION OF THE INVENTION

Hereinafter, preferred embodiments of the gait training device according to the present invention will be explained with reference to proper drawings.

FIG. 1 is a perspective view showing a first embodiment of the gait training device according to the present invention. The gait training device according to the present invention comprises a seat (1) set at the height allowing a user to sit with his feet on the ground, a support member (2) to support said seat at said height, omnidirectional mobile members (3) attached to said support member (2), a forward-falling prevention member (4) which prevents a user sitting on the seat (1) from falling forward, and a control unit (abbreviated in the drawing) to control drive of the omnidirectional mobile members (3).

FIG. 2 is a planar view seen downward from top surface of the seat (1), FIG. 3 is a planar view seen downward from bottom surface of the seat (1), and FIG. 4 is a side view of the gait training device according to the present invention.

The seat (1) has a substantially triangle shape in a planar view, such as a saddle-shape of a bicycle, with its width narrowing ahead, as shown in FIG. 2. This shape allows a user (R) to sit with straddling a front part between his legs while he is sitting on the seat (see FIG. 4). Consequently, the user hardly falls laterally and can easily move his both legs laterally. Therefore, gait training can be easily performed not only back and forth but also side to side or obliquely and can produce beneficial rehabilitation effect.

A support member (2) consists of a support frame (21) to which the omnidirectional mobile members (3) are attached and a strut (22) vertically arranged nearly at the center of the support frame (21), and the seat (1) is fixed to a top end of the strut (22).

The strut (22) has structures (for example, a hydraulic cylinder structure and a screw structure etc.) whose length can be adjustable, and it is possible to adjust the height of the seat (1) by adjusting the length of the strut (22). Accordingly, it is possible to adjust the height of the seat (1) in order to fit a user's body type (such as height and sitting height). For example, since the height of the seat (1) can be adjusted between 400-800 mm, the device can correspond to a user with a height of 150-190 cm.

As described above, since the height of the seat (1) can be adjustable, it is possible to set the seat (1) at the optimal height with respect to individual user and to allow the user to perform continuous gait training in a comfortable position, thereby beneficial rehabilitation effect can be achieved.

The support frame (21) is formed by combining a stick member made of metal, such as aluminum, in a substantially T-shape in a planar view (see FIG. 3), and the omnidirectional mobile members (3) are attached to three ends of T-shape, respectively. However, a shape of the support frame (21) in a planar view may not be limited to T-shape but may be, for example, other shapes such as arc-shape.

On the support frame (21) is mounted a battery (5).

The battery (5) provides electric power to an electric motor (abbreviated in the drawing) for driving the omnidirectional mobile members (3).

As omnidirectional mobile members (3), for instance, an omnidirectional wheel generally called Omni Wheel (trademark) is preferably used, but the member may not be particularly limited to any member with a structure which can move in all directions. It may be a mobile member of a wheel type with a structure different from that of the omnidirectional wheel, and may be a mobile member of a belt type.

In the present invention, the omnidirectional mobile members (3) are preferably used, wherein the members have a structure proposed in Japan Patent No. 4003082, specifically, a structure comprising one or more roller frames to be capable of rotating at a first rotating axis, with the roller frame maintaining a plurality of free rollers along with the periphery thereof and receiving inside thereof a frame-rotating means to rotate the roller frames about the first rotating axis.

The gait training device according to the present invention comprises omnidirectional mobile members (3) to be capable of smoothly moving in all directions, such as not only in a front-back direction but also in a crosswise direction, in an oblique direction, or in a rotation direction. Therefore, it has remarkably beneficial rehabilitation effect and allows for early recovery of walking function.

The number of omnidirectional mobile members (3) is not particularly limited. Three omnidirectional mobile members (3) are shown in the drawings but four or more of them may be provided. If four or more omnidirectional mobile members are provided, a shape of the support frame (21) in a planar view may be preferably arc, for example.

A backrest (6) to support the back of the user sitting on the seat is attached to backward of the seat (1). This backrest (6) allows the user to straighten his posture and prevents the user from falling backward.

A belt member (41) to function as a forward-falling prevention member (4) for preventing the user sitting on the seat (1) from falling forward is attached to the backrest (6).

The belt member (41) consists of a right belt and a left belt, and an engaging member, such as a buckle, is attached to tips of each belts. Consequently, the belt member (41) can be fixedly wrapped around the user (R)'s abdomen by engagement of both belts in front of the abdomen (see FIG. 4).

This prevents the user (R) sitting on the seat (1) from falling forward and allows for safe gait training.

An operating unit (8) to operate the control unit controlling drive of the omnidirectional mobile members (3) is attached to a front part of the seat (1). However, in the present invention, the drive of the omnidirectional mobile members (3) can be achieved by automatic control, such as passive control which determines direction of a user's movement by detecting his balance shift, and in this case, there is no need for the operating unit (8) to be manually operated by a user.

FIG. 5 is a side view showing a second embodiment of the gait training device according to the present invention.

The gait training device according to the second embodiment, as in the first embodiment, comprises a seat (1) set at the height allowing a user to sit with his feet on the ground, a support member (2) to support said seat at said height, omnidirectional mobile members (3) attached to said support member (2), a forward-falling prevention member (4) which prevents a user sitting on the seat (1) from falling forward, a battery (5), and a control unit (abbreviated in the drawing) to control drive of the omnidirectional mobile members (3).

The constitution of the seat (1), the support member (2), the omnidirectional mobile members (3), and the battery (5) is the same as that of the first embodiment and thus detailed description thereof is omitted here. Instead, the forward-falling prevention member (4) which is a different constitution from that of the first embodiment will be explained below.

The gait training device according to the second embodiment comprises a front handle (42) which functions as a forward-falling prevention member (4) for preventing the user sitting on the seat (1) from falling forward.

The front handle (42) is a substantially T-shaped member in a front view and consists of a vertical part (42a) extending up and down and a horizontal part (42b) extending right and left at a top end of the vertical part (42a). The user (R) sitting on the seat (1) can grip with both hands the horizontal part (42b) of the front handle (42) (see FIG. 5).

This leads to prevention of the user (R) sitting on the seat (1) from falling forward and to safe gait training.

FIG. 6 is a side view showing a third embodiment of the gait training device according to the present invention.

The gait training device according to the third embodiment, as in the first embodiment, comprises a seat (1) set at the height allowing a user to sit with his feet on the ground, a support member (2) to support said seat at said height, omnidirectional mobile members (3) attached to said support member (2), a forward-falling prevention member (4) which prevents a user sitting on the seat (1) from falling forward, a battery (5), a backrest (6), and a control unit (abbreviated in the drawing) to control drive of the omnidirectional mobile members (3).

The constitution of the seat (1), the support frame (2), the omnidirectional mobile members (3), the battery (5), and the backrest (6) is the same as that of the first embodiment and thus detailed description thereof is omitted here. Instead, the forward-falling prevention member (4) which is a different constitution from that of the first embodiment will be explained below.

The gait training device according to the third embodiment comprises a guard handle (43) which functions as the forward-falling prevention member (4) for preventing the user sitting on the seat (1) from falling forward.

The guard handle (43) is a U-shaped member in a planar view consisting of a front part (43a) and left-and-right-pair of side parts (43b), both of which are integrally-formed, wherein the front part (43a) extends in a direction so as to come across in front of the user (R) during use and the side parts (43b) extends in a front-back direction at left and right sides of the user (R). Two ends of the side parts (43b) are attached to the top end of the backrest (6) so that the side parts can move around the top end forward and backward. As shown in an imaginary line (a two-dot chain line), this allows for the guard handle (43) to tilt up to approximately 90 degrees angle from behind to front of the user (R). Consequently, the guard handle (43) surrounds front, left, and right sides of the user (R) sitting on the seat (1) while it is tilted forward (see FIG. 6). Furthermore, the user (R) can grip the guard handle (43) with both hands, while the guard handle (43) is surrounding the front, left and right sides of the user (R).

This leads to prevention of the user (R) sitting on the seat (1) from falling forward or laterally and to safe gait training. Besides, at the end of the gait training, the device can return the guard handle backward of the user so that the user can easily move away from the training device.

Hereinafter, kinematics and dynamics for the control of the gait training device according to the present invention (drive control of the omnidirectional mobile members) are derived and shown.

FIG. 7 shows a coordinate setting and a structural model for deriving kinematics and dynamics.

Here, the definition of the coordinate setting and parameters is shown as below.
Σ(x, y, 0): absolute coordinate
Σ(x₁, y₁, G): relative coordinate
F=(f_{f}, f₁, fᵣ)^{T}: drive force vector
V_{G}=(vₓ_{_{G}}, v_{y}_{_{G}})^{T}=(\dot{x}_{G}, \dot{y}_{G})^{T}: moving velocity vector
V=(v_{f}, v₁, vᵣ)^{T}: tangential moving velocity vector of each omnidirectional mobile members
l₁, l₂, l₃: distance from each omnidirectional mobile members to center of gravity of a gait training device
θ(t):angle between x axis and x₁ axis
Φ(t):angle between x axis and direction V_{G}
α: angle between l₁ and l₂
β: angle between l₁ and l₂
M : mass of a gait training device
m : weight of a user
I: moment of inertia

In the above coordinate system, kinematics is shown in a formula (1) and dynamics is shown in a formula (2).

$$\begin{matrix} ( \begin{matrix}- sin ( θ ) & cos ( θ ) & {l}_{1} \\ - sin ( α + θ ) & cos ( α + θ ) & {l}_{2} \\ - sin ( α + β + θ ) & cos ( α + β + θ ) & {l}_{3}\end{matrix} ) ( \begin{matrix}{\dot{x}}_{G} \\ {\dot{y}}_{G} \\ \dot{θ}\end{matrix} ) = ( \begin{matrix}{v}_{f} \\ {v}_{l} \\ {v}_{r}\end{matrix} ) & Formula ( 1 ) \\ ( \begin{matrix}M + m & 0 & 0 \\ 0 & M + m & 0 \\ 0 & 0 & I\end{matrix} ) ( \begin{matrix}{\ddot{x}}_{G} \\ {\ddot{y}}_{G} \\ \ddot{θ}\end{matrix} ) + ( \begin{matrix}sin ( θ ) & sin ( α + θ ) & sin ( α + β + θ ) \\ - cos ( θ ) & - cos ( α + θ ) & - cos ( α + β + θ ) \\ - {l}_{1} & - {l}_{2} & - {l}_{3}\end{matrix} ) ( \begin{matrix}{f}_{f} \\ {f}_{l} \\ {f}_{r}\end{matrix} ) = ( \begin{matrix}0 \\ 0 \\ 0\end{matrix} ) & Formula ( 2 )\end{matrix}$$

The formula (2) is summed up in a formula (3).

$$M ( M , m ) \ddot{X} + H ( α , β , θ ) F = 0 \\ M ( M , m ) = ( \begin{matrix}M + m & 0 & 0 \\ 0 & M + m & 0 \\ 0 & 0 & I\end{matrix} ) , \\ \ddot{X} = ( \begin{matrix}{\ddot{x}}_{G} \\ {\ddot{y}}_{G} \\ \ddot{θ}\end{matrix} ) , \\ F = ( \begin{matrix}{f}_{f} \\ {f}_{l} \\ {f}_{r}\end{matrix} ) \\ H ( α , β , θ ) = ( \begin{matrix}sin ( θ ) & sin ( α + θ ) & sin ( α + β + θ ) \\ - cos ( θ ) & - cos ( α + θ ) & - cos ( α + β + θ ) {l}_{2} \\ - {l}_{1} & - {l}_{2} & - {l}_{3}\end{matrix} ) \qquad Formula ( 3 )$$

Suppose that the following formula (4) is satisfied.

|H(α, β, θ)|=l₁ sin θ−l₂ sin(α+β)+l₃ sin(α) ≠0 Formula (4)

A vector x_{d} expresses desired value of the vector x.

As a control algorism, an error equation shown in a formula (6) will be obtained, if a formula (5) is used. K_{D and K}ₚ are control parameters.

F=H⁻¹M[−\ddot{X}_{d}+K_{D}(\dot{X}−\dot{X}_{d})+Kₚ(X−X_{d})] Formula (5)

ë(t)+K_{D}ė(t)+Kₚe(t)=0

e(t)=X_{d}(t)−X(t) Formula (6)

If the control parameters K_{D} and Kₚ are chosen as follows, the formula (6) becomes a stable ordinary differential equation, and thus a formula (7) is satisfied. That is, the purpose of target trajectory tracking control can be achieved.

K_{P}=diag(ω₁², ω₂², ω₃²)

K_{D}=diag(2ζ₁ω₁, 2ζ₂ω₂, 2ζ₃ω₃)

0<ζᵢ≦1.0, 0<ωᵢ, i=1,2,3

$${lim}_{t \to ∞} e ( t ) = {lim}_{t \to ∞} [ {X}_{d} ( t ) - X ( t ) ] = 0 \qquad Formula ( 7 )$$

Among the above-mentioned formulas (1)-(7), the formulas (1)-(4) derive the motion characteristics (kinematics and dynamics) specific to the gait training device according to the present invention, and the formulas (5)-(7) are general formulas of control algorism (an acceleration control method).

In the present invention, motion control can be achieved by storage on the control unit of a program obtained by the above-described control algorism.

### INDUSTRIAL APPLICABILITY

The gait training device according to the present invention is preferably used as a gait training device for those with severe gait disorders who have lost muscle strength to support the upper bodies, and can be applicable not only in hospitals or care welfare facilities but also in small houses.

### EXPLANATION OF NUMBERS

1 Seat

2 Support Member

21 Support Frame

22 Strut

3 Omnidirectional mobile members

4 Forward-falling prevention member

41 Belt Member

42 Front Handle

43 Guard Handle

5 Battery

6 Backrest

R User

1. A gait training device, comprising;
a seat set at the height allowing a user to sit with his feet on the ground,
a support member to support said seat, and
omnidirectional mobile members attached to said support member,
wherein, drive control of the omnidirectional mobile member is performed by target trajectory tracking control.

2. The gait training device according to claim 1, comprising a forward-falling prevention member which prevents a user sitting on the seat from falling forward.

3. The gait training device according to claim 2, comprising a backrest to support the back of a user sitting on said seat,
wherein said forward-falling prevention member consists of comprises a substantially U-shaped guard handle in a planar view which can tilt from behind to front of the user about said backrest set as a supporting point and surround front, left, and right sides of the user sitting on said seat while it is tilted forward.

4. The gait training device according to claim 2, comprising a backrest to support the back of a user sitting on said seat,
wherein said forward-falling prevention member comprises a belt member attached to said backrest which can be wrapped around user's abdomen.

5. The gait training device according to claim 2, wherein said forward-falling prevention member comprises a substantially T-shaped front handle in a front view which is provided at the front of said seat and can be gripped with both hands of the user sitting on said seat.

6. The gait training device according claim 1, wherein said seat is constituted so that its height can be adjustable.
